(19) United States
(12) Patent Application Publication
(10) Pub. No.: US 2006/0288193 A1
(43) Pub. Date: Dec. 21, 2006

(54) Register-collecting mechanism for multi-threaded processors and method using the same

(75) Inventor: R-ming Hsu, Jhudong Township (TW)

Correspondence Address: TROXELL LAW OFFICE PLLC, SUITE 1404, 5205 LEESBURG PIKE, FALLS CHURCH, VA, 22041, US

(73) Assignee: Silicon Integrated System Corp.

(21) Appl. No.: 11/143,674

(22) Filed: Jun. 3, 2005

(51) Int. Cl. G06F 9/30

(52) U.S. Cl. 712/217

(57) ABSTRACT

A register-collecting mechanism and method using the same for multi-threaded processors are described. The register-collecting mechanism includes an instruction scanner, a register mapping table, an instruction modifier and an indication reporter. The instruction scanner scans one or more first programs having a plurality of first instructions and decode each of the first instructions to extract a plurality of nominal register numbers from the first instructions. The register mapping table compares the nominal register numbers of the first instructions to determine whether to collect a plurality of physical register numbers in sequence of register numbers when at least one of the nominal register numbers is unmapped with respective physical register number previously stored within the register mapping table. The instruction modifier is able to correct the nominal register numbers to generate a second program having a plurality of second instructions which are composed of the sequential physical register numbers collected in the register mapping table.

### FIELD OF THE INVENTION

The present invention generally relates to a mechanism and method for multi-threaded processors, and more particularly, to a register-collecting mechanism and method using the same for the multi-threaded processors.

### BACKGROUND OF THE INVENTION

Referring to FIG. 1A, a conventional single-threaded processor is shown. Generally, the single-threaded processor fetches the current or next instruction, from a program 102a, according to a programming counter (PC) 100a, in order to generate a single thread 104a operable for an execution resource 106a to output desired result. A register 108a defined in the program 102a are allocated to the single thread 104a of a fetched instruction, serving as a source and target of operational data for the single thread 104a. In other words, each single thread 104a involves at least a programming counter 100a and a register 108a.

Further, FIG. 1B shows a conventional multi-threaded processor utilized for enhancing processing speed. Meanwhile, the multi-threaded processor fetches at least a part of multiple instructions from several programs (P₁, P₂, . . . , P_{N}) 102b, according to a plurality of programming counters (PC₁, PC₂, . . . , PC_{N}) 100b, in order to generate a plurality of threads 104b, respectively. Further, a plurality of registers or a called register set (R₁, R₂, . . . , R_{N}) 108b receive decoded instructions from the programming counters 100b. The execution resource 106b then selectively or simultaneously executes the operations of those threads 104b.

Since each programming counter (100a, 100b) and register set (108a, 108b) used for the threads (104a, 104b) have to be retained all the time as long as the execution resources (106a, 106b) processes the threads (104a, 104b), the register sets (108a, 108b) should be increased more and more. As the gradually increased registers are specified, these registers occupy more space of an internal buffer memory and considerably make constraints on the numbers of the operable threads (104a, 104b) thus. Especially in a graphic processing unit (GPU) which extreme lacks support of an external memory, thus more and more registers are specified for incoming special effects. However, in most of normal effects, these over specified registers will be ineffectively used.

For the above-mentioned problem, a conventional solution that uses renaming registers in an out-of-order processing processor is proposed to avoid gradual increment of the numbers of registers. An embodiment of this technology is discussed in U.S. Pat. No. 6,314,511, entitled to “Mechanism for freeing registers on processors that perform dynamic out-of-order execution of instructions using renaming registers”. However, the register-renaming mechanism is combined with the complicated out-of-order mechanisms. In other words, after instructions are fetched and then decoded, the register-renaming mechanism is dynamically performed to rename the registers to index re-order buffers that only appear in out-of-order mechanisms. Therefore, the register-renaming mechanism for the out-of-order processing processor is more complicated than for the in-order processing processors.

As aforementioned, either a single thread or multi-threaded processors in which registers serve as a temporary buffer for storing operation data of the thread and can not afford the demand of increasingly specified register set. Consequently, there is a need to develop a register-collecting mechanism with an ability to provide the multi-threaded processor with lesser but fully utilized registers thereby reducing the numbers of operable registers and raising up operation efficiency of multi-threads.

### SUMMARY OF THE INVENTION

One object of the present invention is to provide a register-collecting mechanism and method thereof to adjustably gather lesser registers in sequence to be a source and target of operational data of multiple threads of several programs before the programs are fetched or decoded by a multi-threaded processor.

Another object of the present invention is to provide a multi-threaded processor with a register-collecting mechanism and method thereof to reassign nominal register numbers of several programs in advance to be physical register numbers and further archive an amount indicator of the physical register numbers issued from the register-collecting mechanism so that the processor is able to predict the demand of the physical register numbers for correspondence to run more threads.

According to the above objects, the present invention sets forth a register-collecting mechanism for multi-threaded processors and method using the same. The register-collecting mechanism suitable for multi-threaded processors in a computer system includes an instruction scanner, a register mapping table, an instruction modifier and an indication reporter.

The instruction scanner is used to scan one or more first programs having a plurality of first instructions and simultaneously decode each first instruction to extract a plurality of nominal register numbers originally allocated to the first instructions. The register mapping table coupled to the instruction scanner is provided for collecting a plurality of physical register numbers in sequence of register numbers that includes previous physical register numbers stored within the register mapping table if any one of nominal register numbers is unmapped with the respective previous-stored physical register number. Further, the last one of the sequential physical register numbers represents the amount indicator of physical registers number allocated to the first programs and is lesser than that of the nominal register numbers. The instruction modifier coupled to the instruction scanner and the register mapping table is used to correct the nominal register numbers to generate a second program having a plurality of second instructions which are composed of the sequential physical register numbers in the register mapping table. Thus, the second programs are composed of a plurality of second instructions having the sequential physical register numbers.

A method of performing a register-gathering mechanism for a multi-threaded processor is described as follows. Once a first program is loaded into the register-collecting mechanism, the related mapping data are cleared from the register mapping table to initially reset the mapping status regarding the previous nominal and physical register numbers. At least one program having a plurality of instructions is statically scanned, from top to bottom, by an instruction scanner. Thereafter, the instructions are serially decoded to extract a plurality of nominal register numbers in sequence. Next, each of the nominal register numbers of instructions is compared with respective physical register numbers previously stored within a register mapping table in order to determine whether to automatically collect a plurality of physical register numbers in sequence of register numbers that includes the previous-stored physical register numbers if at least one of the nominal register numbers is unmapped with or different from the physical register numbers previously stored within the register mapping table. The last one of the physical register numbers preferably represents an amount indicator of the physical register numbers allocated to the multi-threaded processor and is lesser than that of the nominal register numbers.

If the step of comparing the nominal register numbers with the physical register numbers of the register mapping table is negative, i.e. unmapped, at least one of the nominal register numbers is mapped to a physical register number which is collectedly posterior to the last one of the sequential physical register numbers while at least one of the nominal registers is newly added to the register mapping table. Then, the mapping status or matched relationship between the nominal register number and physical register number is then recorded or updated within the register mapping table. Finally, a step of sequentially increasing the amount indicator of the physical register numbers in response to the mapping status of the sequential physical register numbers is performed. If the step of comparing the nominal register numbers with the physical register numbers of the register mapping table is positive, i.e. mapped, the nominal register number is corrected to generate a second program having a plurality of second instructions. In another word, the nominal register number is one of the existing physical register numbers with a sequential order. Thus, the second program is composed of the physical register numbers and preferably stored in the register mapping table.

The advantages of the present invention include: (a) providing enough registers for executing more threads to reduce the manufacturing cost of the multi-threaded processors, (b) statically reassigning the nominal register numbers of the programs in advance to generate an amount indicator issued from the register-collecting mechanism so that the processor is able to run more threads, and (c) providing a register-collecting mechanism and method thereof to efficiently utilize the physical registers allocated to the programs within multi-threaded processors.

### BRIEF DESCRIPTION OF THE DRAWINGS

FIG. 1A shows a conventional single-threaded processor.

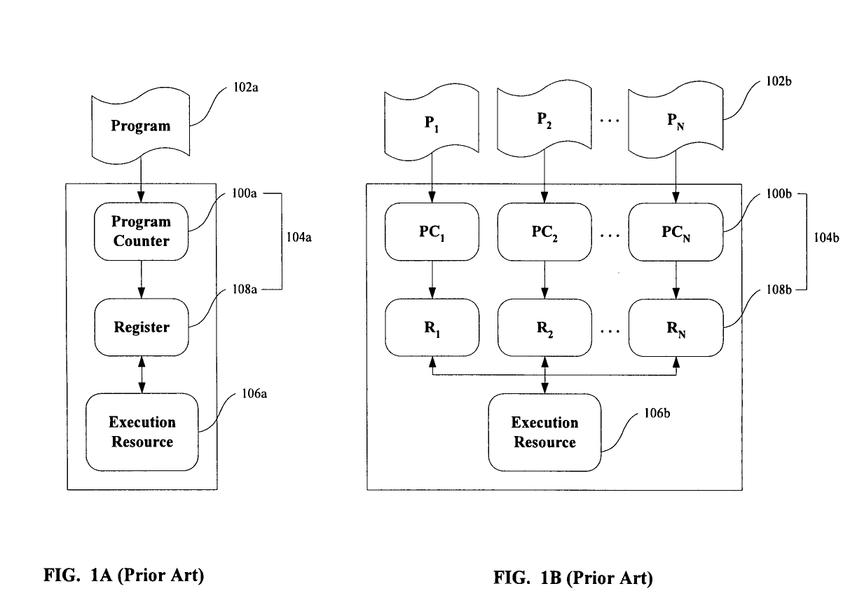

FIG. 1B shows a conventional multi-threaded processor.

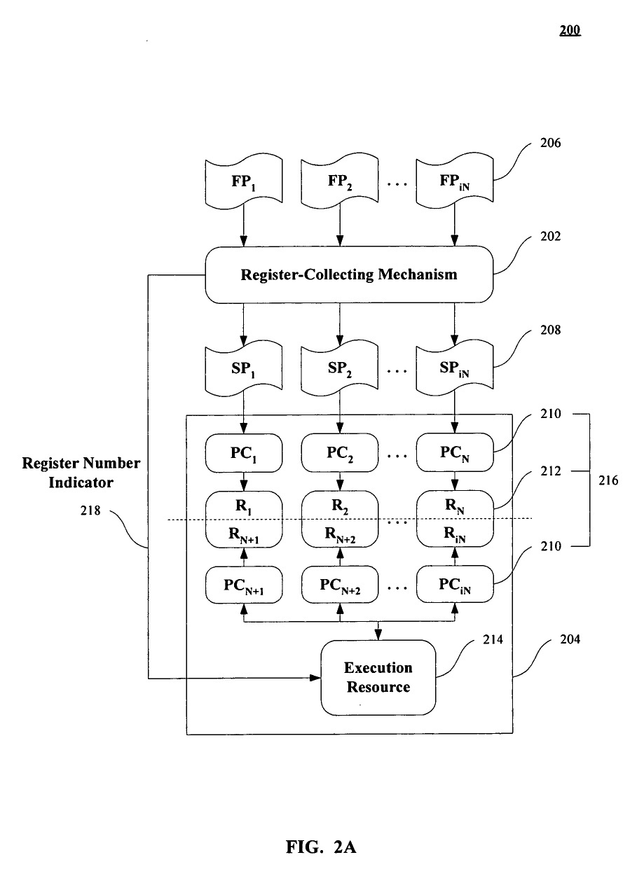

FIG. 2A illustrates a block diagram of a multi-threaded processor with a register-collecting mechanism, in which a plurality of threads of second programs are executed and increased from N to iN according to one embodiment of the present invention.

FIG. 2B illustrates a block diagram of a multi-threaded processor with a register-collecting mechanism, in which a plurality of threads of second program are executed and increased from N to iN according to another embodiment of the present invention.

FIG. 3 illustrates a detailed block diagram of register-collecting mechanism implemented for the multi-threaded processor in FIG. 2 according to the present invention.

FIG. 4A illustrates a block diagram of register-collecting mechanism implemented by scanning programs within the multi-threaded processor in FIG. 3 according to first embodiment of the present invention.

FIG. 4B illustrates a block diagram of register-collecting mechanism implemented by scanning programs within the multi-threaded processor in FIG. 3 according to second embodiment of the present invention.

FIG. 5A-5B show a flow chart of performing a multi-threaded processor with register-collecting mechanism according to the present invention.

### DETAILED DESCRIPTION OF THE PREFERRED EMBODIMENTS

The present invention is directed to a register-collecting mechanism and method thereof to gather more registers for concurrently executing more threads of the programs which are run in a multi-threaded processor before the instructions of programs are forwarded to the processor or before these instructions are fetched or decoded in the processor. Further, the register-collecting mechanism and method thereof efficiently utilizes the physical registers allocated to the programs within the processor. Moreover, by using an amount indicator issued from an indication reporter of the register-collecting mechanism, the mapping status of physical registers in the multi-threaded processor can be managed to get more threads for execution. The multi-threaded processors preferably comprises single instruction multiple data processors (SIMDs), i.e. digital signal processors (DSPs) and graphic processing units (GPUs) in the present invention.

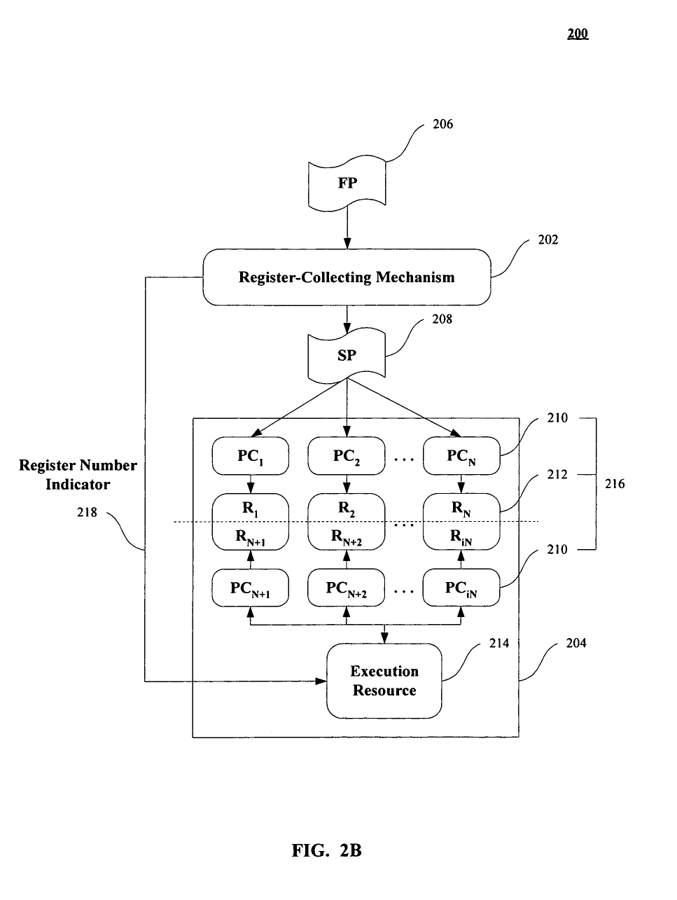

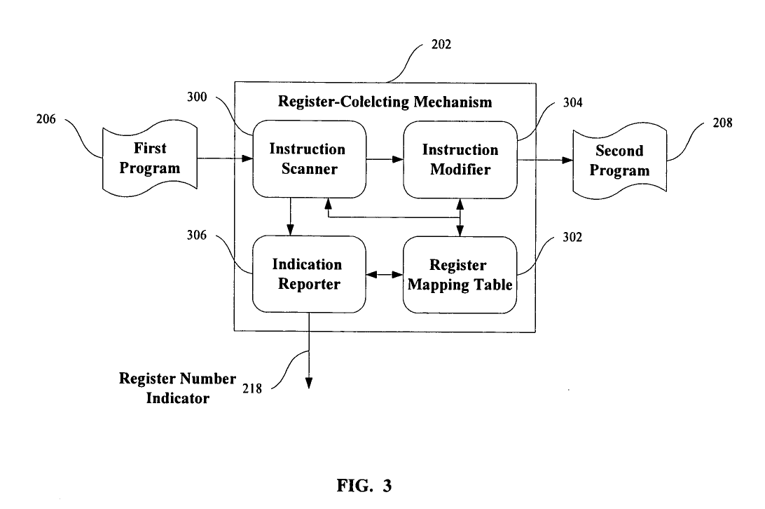

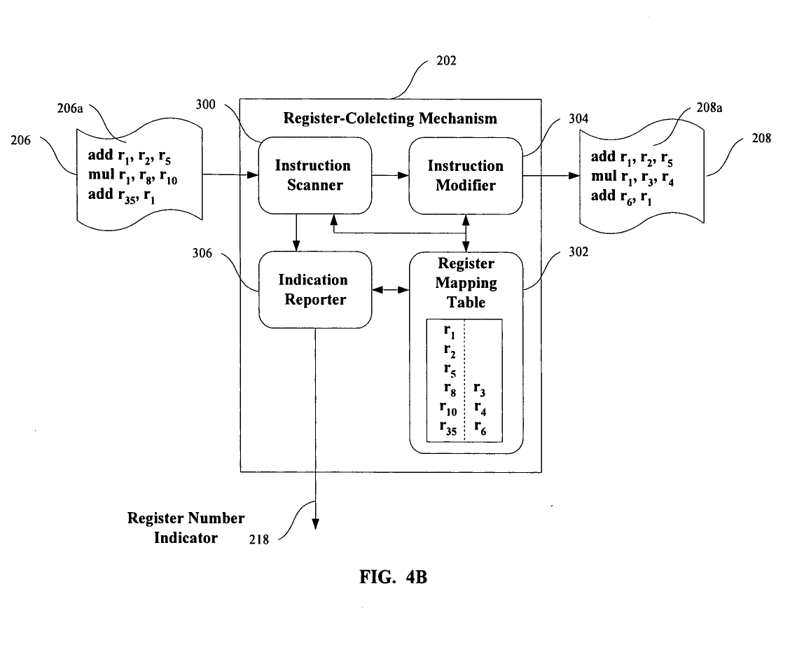

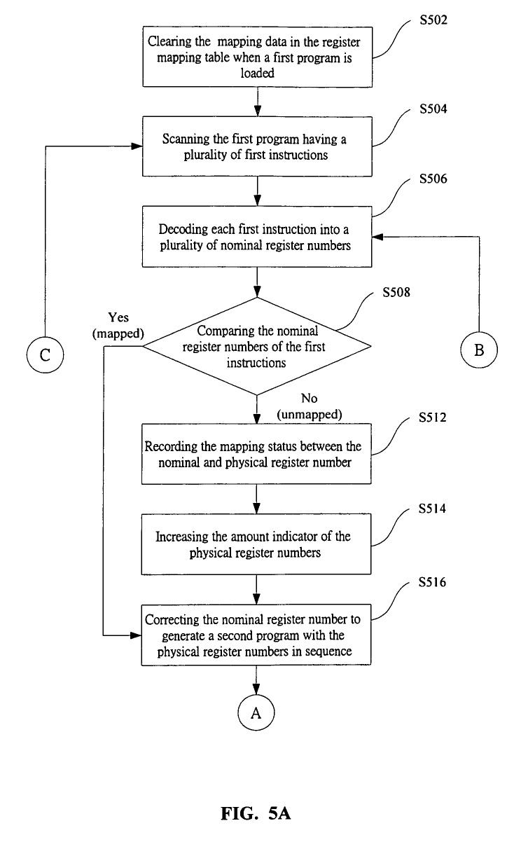

FIG. 2A shows a block diagram of a multi-threaded processor with a register-collecting mechanism, in which a plurality of threads of second programs are executed and increased from N to iN according to one embodiment of the present invention. The multi-threaded processor 200 includes a register-collecting unit 202 and a processing unit 204. The register-collecting unit 202 compares the nominal register numbers (shown in FIGS. 4A and 4B) 206a of first programs (named as FP₁, FP₂, . . . , FP_{iN}, respectively) 206 with a plurality of physical register numbers (also shown in FIGS. 4A and 4B) 208a of second programs (named as SP₁, SP₂, . . . , SP_{iN}, respectively) 208 in the register mapping table to reassign the nominal register numbers. The mapping status or matched relationship between the nominal register numbers 206a and the physical register numbers are preferably recorded in the register-collecting unit 202 or memory coupled to register-collecting unit. Thus, the physical register numbers with a sequential order are used to correct the nominal register numbers 206a to statically regenerate the second programs (SP₁, SP₂, . . . , SP_{iN}) 208.

In some techniques of single instruction multiple data (SIMD) processors, such as digital signal processors (DSPs) and graphic processing units (GPUs), multi-threading are preferably used for executing different partitions of the data stream by in-order execution. In this case, all the threads are fetching the same program, as shown in FIG. 2B.

FIG. 2B shows a block diagram of a multi-threaded processor with a register-collecting mechanism, in which a plurality of threads of one second program are executed and increased from N to iN according to another embodiment of the present invention. The register-collecting unit 202 compares the nominal register numbers (shown in FIGS. 4A and 4B) 206a of one first program (named as FP) 206 with a plurality of physical register numbers (also shown in FIGS. 4A and 4B) 208a of one second program (named as SP) 208 in the register mapping table to reassign the nominal register numbers. The mapping status or matched relationship between the nominal register numbers 206a and the physical register numbers are also recorded in the register-collecting unit 202 or memory coupled to register-collecting unit. Thus, the physical register numbers with a sequential order are used to correct the nominal register numbers 206a to statically regenerate the second program (SP) 208.

The second programs 208 from the register-collecting unit 202 run in the processing unit 204 which includes a plurality of programming counters 210, physical registers 212 and an execution resource 214. Specifically, the programming counters 210 are used to keep track of the address of the current or next instruction of the second programs 208. The physical registers 212 are mapped to the physical register numbers 208a and allocated to the programming counters 210 to act as buffer of execution data of the threads 216. It is noted that the threads 216 are composed of the programming counters 210 and physical registers 212. The execution resource 214 coupled to the physical registers 212 is used to implement the threads 216 according to the amount indicator 218, i.e. register amount indicator, of physical register numbers 208a from the register-collecting unit 202. As a result, the amount indicator 218 of the increased registers between the nominal and the physical register numbers (206a, 208a) are available to physical register 212 reallocation for the processing unit 204.

The number of physical registers 212 assigned to the first programs 206 is generally defined by the instruction set, but some of the physical registers 212 are not fully utilized by the threads 216 of the second programs 208 in the prior art. For most applications, although all the physical registers 212 defined by the register set can be utilized, however, the load/store instructions will be used to access additional instructions temporarily buffered in the memory when the physical registers 212 are still not enough to store the instructions. For example, since the graphics processing unit is lack of memory architecture, many additional physical registers must to be prepared for the instruction set in order to process more complicated programs regarding graphic objects. As a result, the multi-threaded processor with a register-collecting mechanism is advantageously suitable for a graphics processing unit (GPU) in the present invention. For in-order processing multi-threaded processors, the present invention can improve huge dynamic renaming registers described in U.S. Pat. No. 6,314,511, which focuses on out-of-order processing processors. However, even in out-of-order processing mechanisms, the present invention provides a much cheaper solution.

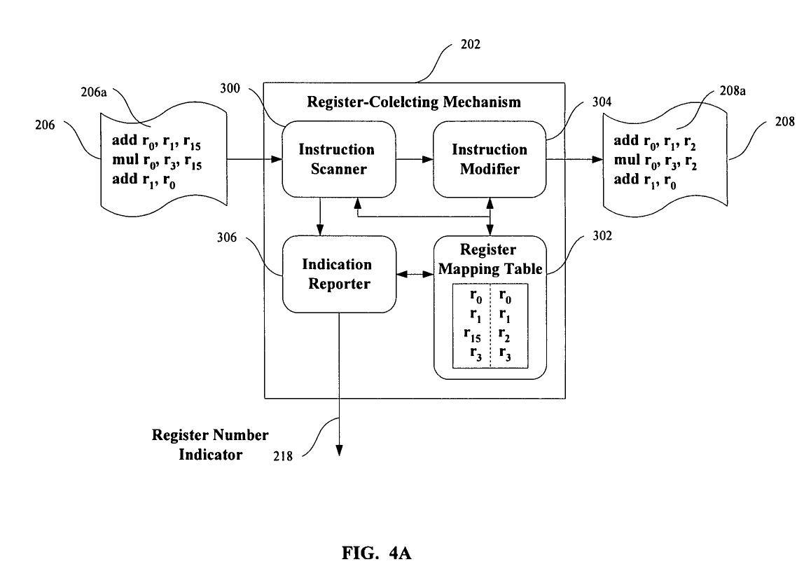

FIG. 3 illustrates a detailed block diagram of register-collecting mechanism 202 implemented for the multi-threaded processor in FIG. 2 according to the present invention. The register-collecting mechanism 202 suitable for multi-threaded processors in a computer system includes an instruction scanner 300, a register mapping table 302, an instruction modifier 304 and an indication reporter 306.

The instruction scanner 300 is used to scan one or more first programs 206 having a plurality of first instructions and simultaneously decode each of the first instructions to extract a plurality of nominal register numbers 206a from the first instructions. The register mapping table 302 coupled to the instruction scanner 300 is able to compare the nominal register numbers 206a of the first instructions with respective physical register numbers 208a previously stored within a register mapping table 302 in order to determine whether to automatically collect a plurality of physical register numbers 208a in sequence of register numbers that includes the previous-stored physical register numbers when at least one of the nominal register numbers 206a is unmapped with or different from the physical register numbers 208a previously stored within the register mapping table 302.

Further, the last one of sequential physical register numbers 208a represents the amount indicator 218 of physical registers 212 allocated to the first programs 206 and is lesser than that of the nominal register numbers 206a. The instruction modifier 304 coupled to the instruction scanner and the register mapping table 302 to correct the nominal register numbers 206a to generate a second program 208 having a plurality of second instructions which are composed of the sequential physical register numbers 208a in the register mapping table 302. Thus, the second programs 208 are composed of a plurality of second instructions having the sequential physical register numbers.

More importantly, the register-collecting mechanism 202 also comprises an indication reporter 306 to send an amount indicator 218 of the physical register numbers 208a to the multi-threaded processor so that the multi-threaded processor is capable of performing more programs according to the amount indicator 218. In other words, the multi-threaded processor implements the instructions of the program at a minimum number of physical registers to save the processor more physical register 212. Additionally, each of the nominal register numbers 206a preferably has a source register number and target register number to store execution data of the instructions of the first programs 206.

In one embedment, the amount indicator 218 is the number of the physical registers 212 allocated to the second programs 208, the number of threads concurrently executed by the multi-threaded processor, or a plurality of different execution modes of the threads concurrently processed by the multi-threaded processor to make more flexible when processing the threads.

Next, in one preferred embodiment, the register-collecting mechanism 202 can be implemented in form of hardware or software, as shown in FIG. 2 and FIG. 3. In view of software, the register-collecting mechanism 202 is a software tool kit running in an operating system (OS), a portion of program loader or a device driver. Furthermore, in view of hardware, the register-collecting mechanism 202 is preferably connected to the input portion of the programming counters 210, instruction fetcher or decoder, or can be built in the multi-threaded unit 204, which is defined as a static mode in contrast with a dynamic mode that the instructions are first fetched by the decoder. The register-collecting mechanism 202 makes physical registers 212 available for more threads 216 since the first programs are statically scanned to regenerate the simplified second programs by the register-collecting mechanism.

FIG. 4A illustrates a block diagram of register-collecting mechanism implemented by scanning programs within the multi-threaded processor in FIG. 3 according to first embodiment of the present invention. In this embodiment, the assigned instructions with nominal register numbers 206a, r₀˜r₁₅, are scanned and decoded by the instruction scanner 300, where the nominal register numbers 206a of the instructions of the first programs are sixteen, i.e. r₀˜r₁₅ in the left-hand column of the register mapping table. The nominal register r₁₅ is reassigned to r₂ using the register mapping table 302 such that r₁₅ is replaced with r₂. The physical register number r₂ is the one of sequential order of the physical register numbers 208a, r₀˜r₃, in the right-hand column. The mapping status or matched relationship between the nominal register numbers 206a, i.e. r₀˜r₁₅, and physical register numbers 208a, i.e. r₀˜r₃ are then recorded and stored in the register mapping table 302.

FIG. 4B illustrates a block diagram of register-collecting mechanism implemented by scanning programs within the multi-threaded processor in FIG. 3 according to second embodiment of the present invention. In this case, the assigned instructions with nominal register numbers 206a, r₁, r₂, r₅, r₈, r₁₀, r₃₅, are scanned and decoded by the instruction scanner 300, where the nominal register numbers 206a of the instructions used by the first programs are thirty-five, i.e. r₁˜r₃₅ in the left-hand column of the register mapping table. The nominal register r₃₅ is reassigned to r₆ using the register mapping table 302 such that r₃₅ is replaced with r₆. The physical register number r₆ is the one of sequential order of the physical register numbers 208a of r₁˜r₆ in the right-hand column. The remaining of physical register numbers, i.e. r₈ and r₁₀, are reassigned respectively to r₃ and r₄ of sequential order of the physical register numbers 208a, r₁˜r₆, in the right-hand column such that r₈ and r₁₀ are replaced with r₃ and r₄. Further, the nominal register numbers 206a, r₁, r₂, r₅ is invariably corresponding to r₁, r₂, r₅ of physical register numbers. Namely, the numbers of the nominal register numbers 206a, r₁, r₂, r₅, are not changed. As a result, the mapping status or matched relationship between the nominal register numbers 206a, i.e. r₁, r₂, r₅, r₈, r₁₀, r₃₅, and physical register numbers 208a, i.e. r₁˜r₆ are rapidly recorded and stored in the register mapping table 302.

Moreover, an amount indicator 218 of the mapping status is sent to the multi-threaded processor to determine the number of physical registers 212 in FIG. 2 to be reassigned to the program. When only four registers including r₀, r₁, r₃, and r₁₅ are used for the implemented program, the remaining of the physical register, r₂ and r₄˜r₁₅, can further be utilized for more threads generated from one or more programs. Consequently, the multi-threaded processor allows itself to implement up to four times the number of the threads.

As shown in FIG. 2 and FIG. 4 according to one embodiment of the present invention, before the first programs (FP₁, FP₂, . . . , FP_{iN}) 206 are input into register-collecting mechanism 202, the number of nominal registers allocated to the first programs 206 is defined as “t₁”. On other hand, after the first programs (FP₁, FP₂, . . . , FP_{iN}) 206 are input into register-collecting mechanism 202 and processed, the physical register numbers 208a allocated to the output second programs 208 corresponding to the first programs 206 are defined as “t₂”. The ratio “i” of t1 to t2 (i=t₁/t₂) indicates the utilization status of the physical registers 212 assigned to the first and second programs (206, 208), where “i” is a positive number and preferably natural number.

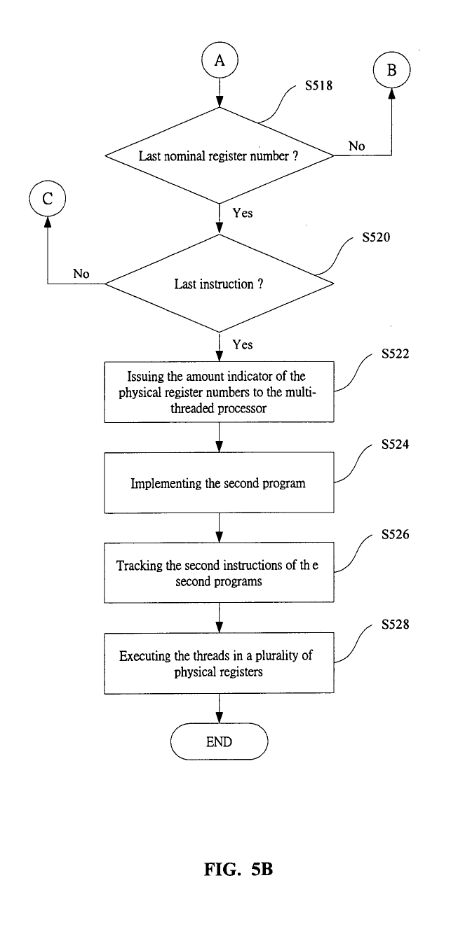

Referring to FIG. 5, a flow chart of performing a multi-threaded processor with register-collecting mechanism according to the present invention is shown. Starting at step S502, the related mapping data are cleared from the register mapping table to initially reset the mapping status regarding the previous nominal and physical register numbers when a first program is loaded into the register-collecting mechanism. In step S504, at least one program having a plurality of instructions is statically, from top to bottom, scanned using an instruction scanner, as shown in step S504. In step S506, the scanned instructions are serially decoded to extract a plurality of nominal register numbers.

Thereafter, in the decision step S508, each of the nominal register numbers of instructions is compared with respective physical register numbers previously stored within a register mapping table in order to determine whether to automatically collect a plurality of physical register numbers in sequence of register numbers that includes the previous-stored physical register numbers if at least one of the nominal register numbers is unmapped with or different from the physical register numbers previously stored within the register mapping table. The last one of sequential physical register numbers preferably represents an amount indicator of the physical register numbers allocated to the multi-threaded processor and is lesser than that of the nominal register numbers.

If the determination at the decision step S508 is negative, i.e. unmapped, at least one of the nominal register numbers is mapped to a register number which is collectedly posterior to the last one of the sequential physical register numbers while at least one of the nominal registers is newly added to the register mapping table. In step 512, the mapping status or matched relationship between the nominal register number and physical register number is then recorded within the register mapping table. Finally, step S514 of sequentially increasing the amount indicator of the physical register numbers in response to the mapping status is performed. If the determination at the decision step S508 is positive, i.e. mapped, the nominal register number is corrected to generate a second program having a plurality of second instructions, as shown in step S516. In another word, the nominal register number is one of the existing physical register numbers with a sequential order. The second program is composed of the physical register numbers and preferably stored in the register mapping table.

Proceeding to the decision step S518, step S520 is performed if the last one of nominal register numbers is complete, and return to step S506 to extract the next nominal register number from the same instruction when the determination at the decision step S518 is negative. In the decision step S520, if the last one of the first instructions is complete, step S520 is then performed and return to step S504 to statically scan the next first instruction using the instruction scanner.

As shown in step S522, by issuing the amount indicator of the physical register numbers to the multi-threaded processor, the multi-threaded processor receives indication to manage the physical registers therein to process more threads creating by one or more programs. For the multi-threaded processor, in step S524, the second program having the sequential physical register numbers in the multi-threaded processor is implemented. The second instructions of the second programs are tracked to fetch the second instructions for generating a plurality of threads using programming counters, as shown in step S526. In step S528, the threads in a plurality of physical registers corresponding to the sequential physical register numbers are executed.

The advantages of the present invention are: (a) providing enough registers for executing more threads to reduce the manufacturing cost; (b) statically reassigning the nominal register numbers of the programs in advance to generate an amount indicator issued from the register-collecting mechanism so that the processor is able to run more threads; (c) providing a register-collecting mechanism and method thereof to efficiently utilize the physical registers allocated to the programs within multi-threaded processors; and (d) the SIMD processors, i.e. DSPs and GPUs, with in-order execution, even in out-of-order processing processors, the present invention can work as a much cheaper solution.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A register-collecting mechanism for a multi-threaded processor, comprising:
an instruction scanner, scanning at least one first program having at least one first instruction to produce at least one first register number;
a register mapping table coupled to the instruction scanner, collecting a plurality of second register numbers corresponding to the first register numbers; and
an instruction modifier coupled to the instruction scanner and the register mapping table, correcting the first register numbers to generate at least one second program having a plurality of second instructions which are composed of the second register numbers collected in the register mapping table.

2. The register-collecting mechanism of claim 1, wherein the second register numbers in the register mapping table are a plurality of sequential register numbers when at least one of the first register numbers is unmapped with respective second register numbers previously stored within the register mapping table.

3. The register-collecting mechanism of claim 2, wherein the first register numbers are a plurality of nominal register numbers allocated to the first programs.

4. The register-collecting mechanism of claim 3, wherein the second register numbers are a plurality of physical register numbers allocated to the second programs.

5. The register-collecting mechanism of claim 4, wherein the last one of sequential physical register numbers represents an amount indicator of the physical register numbers allocated to the multi-threaded processor and is lesser than that of the nominal register numbers.

6. The register-collecting mechanism of claim 1, further comprising an indication reporter to issue an amount indicator of a plurality of physical registers to the multi-threaded processor.

7. The register-collecting mechanism of claim 6, wherein the amount indicator is a plurality of threads executed in the multi-threaded processor.

8. The register-collecting mechanism of claim 6, wherein the amount indicator is a plurality of different execution modes of the threads processed in the multi-threaded processor.

9. The register-collecting mechanism of claim 6, wherein the amount indicator is the number of physical registers allocated to the second program.

10. The register-collecting mechanism of claim 1, wherein the second instructions of the second program corrected by the instruction modifier are performed in in-order execution for the multi-threaded processor.

11. The register-collecting mechanism of claim 1, wherein the second instructions of the second program corrected by the instruction modifier are performed in out-of-order execution for the multi-threaded processor.

12. A multi-threaded processor comprising:
a register-collecting unit, comprising:
an instruction scanner, scanning at least one first program having at least one first instruction to produce at least one first register number;
a register mapping table coupled to the instruction scanner, comparing the first register numbers of the first instructions with a plurality of second register numbers in the register mapping table to determine whether automatically collect a plurality of second register numbers corresponding to the first register numbers; and
an instruction modifier coupled to the instruction scanner and the register mapping table, correcting the first register numbers to generate a second program having a plurality of second instructions which are composed of the second register numbers in the register mapping table; and
a processing unit coupled to the register-collecting unit to implement the second program from the instruction modifier of the register-collecting unit.

13. The multi-threaded processor of claim 12, wherein the last one of second register numbers represents an amount indicator of the second register numbers allocated to the multi-threaded processor and is lesser than that of the first register numbers.

14. The multi-threaded processor of claim 13, wherein the first register numbers are a plurality of nominal register numbers allocated to the first programs.

15. The multi-threaded processor of claim 14, wherein the second register numbers are sequential and represents a plurality of physical register numbers allocated to the second programs.

16. The multi-threaded processor of claim 12, further comprising an indication reporter coupled to the instruction scanner and the register mapping table for issuing the amount indicator of physical registers to the multi-threaded processor.

17. The multi-threaded processor of claim 12, wherein the processing unit comprises:
a plurality of programming counters tracking the second instructions of the second programs so that the processing unit is able to fetch the second instructions for generating a plurality of threads; and
a plurality of physical registers corresponding to the second register numbers respectively and allocated to the programming counters to store execution data of the threads.

18. The multi-threaded processor of claim 17, further comprising an execution resource coupled to the physical registers to execute a plurality of threads in a plurality of physical registers corresponding to the second register numbers to generate the execution data.

19. The multi-threaded processor of claim 18, wherein the amount indicator is the number of the threads executed in the multi-threaded processor.

20. The multi-threaded processor of claim 18, wherein the amount indicator is a plurality of different execution modes of the threads processed in the multi-threaded processor.

21. The multi-threaded processor of claim 18, wherein the amount indicator is the number of a plurality of physical registers allocated to the second program.

22. The multi-threaded processor of claim 12, wherein the second instructions of the second program corrected by the instruction modifier are performed in in-order execution for the processing unit.

23. The multi-threaded processor of claim 12, wherein the second instructions of the second program corrected by the instruction modifier are performed in out-of-order execution for the processing unit.

24. A method of performing a register-collecting mechanism for a multi-threaded processor, comprising the steps of:
scanning at least one first program having at least one first instruction;
decoding the first instructions into a plurality of first register numbers;
comparing the first register numbers of the first instructions with respective second register numbers previously stored in a register mapping table to determine whether to automatically collect a plurality of second register numbers corresponding to the first register numbers; and
correcting the first register numbers to generate a second program having a plurality of second instructions which are composed of the second register numbers in the register mapping table.

25. The method of claim 24, during the step of comparing the first register numbers of the first instructions, wherein the last one of second register numbers represents an amount indicator of the second register numbers allocated to the multi-threaded processor and is lesser than that of the first register numbers.

26. The method of claim 25, wherein the first register numbers are a plurality of nominal register numbers allocated to the first programs.

27. The method of claim 26, wherein the second register numbers are sequential and represents a plurality of physical register numbers allocated to the second programs.

28. The method of claim 27, after the step of correcting the first register numbers, further comprising a step of issuing the amount indicator of the second register numbers to the multi-threaded processor.

29. The method of claim 28, after the step of issuing the amount indicator of second register numbers, further comprising a step of implementing the second program having the sequential physical register numbers in the multi-threaded processor.

30. The method of claim 29, during the step of implementing the second program, further comprising a step of tracking the second instructions of the second programs to fetch the second instructions for generating a plurality of threads.

31. The method of claim 30, after the step of tracking the second instructions of the second programs, further comprising a step of executing the threads in a plurality of physical registers corresponding to the sequential physical register numbers.

32. The method of claim 31, wherein the amount indicator is the number of the threads executed in the multi-threaded processor.

33. The method of claim 31, wherein the amount indicator is a plurality of different execution modes of the threads processed in the multi-threaded processor.

34. The method of claim 31, wherein the amount indicator is the number of a plurality of physical registers allocated to the second program.

35. The method of claim 27, after the step of comparing the nominal register numbers of the first instructions, further comprising a step of recording a mapping status between the nominal register numbers and physical register numbers which is collectedly posterior to the last one of sequential physical register numbers while the one of the nominal registers is newly added to the register mapping table.

36. The method of claim 35, after the step of recording the mapping status between the nominal register numbers and physical register numbers, further comprising a step of sequentially increasing the amount indicator of the physical register numbers in response to the mapping status.

37. The method of claim 24, before the step of scanning the first program, further comprising a step of clearing the register mapping table when the first program is loaded.

38. The method of claim 24, during the step of correcting the first register numbers, comprising a step of correcting the total of the first register numbers.

39. The method of claim 24, during the step of correcting the first register numbers, comprising a step of correcting a portion of the first register numbers greater than the indicator amount.

40. The method of claim 24, wherein the second instructions of the second program corrected are performed in in-order execution for the multi-threaded processor.

41. The method of claim 24, wherein the second instructions of the second program corrected are performed in out-of-order execution for the multi-threaded processor.
